(19) United States
(12) Patent Application Publication
(10) Pub. No.: US 2005/0210229 A1
(43) Pub. Date: Sep. 22, 2005

(54) Method and system for configuration of processor integrated devices in multi-processor systems

(76) Inventors: Prashant Sethi, Folsom, CA (US); Kenneth C. Creta, Gig Harbor, WA (US); Raymond Scott Tetrick, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/806,787

(22) Filed: Mar. 22, 2004

(51) Int. Cl. G06F 9/00

(52) U.S. Cl. 713/1

(57) ABSTRACT

The ability to configure an integrated device with a decoder in a processor or network component according to PCI or PCI Express interconnects.

### BACKGROUND

1. Field

This disclosure generally relates to configuration, specifically, relating to configuration of integrated devices incorporated within processors or network components in multi-processor systems.

2. Background Information

Presently, processors are incorporated along with other integrated devices, such as, memory controllers or coprocessors into a single integrated device package. The corresponding processor package is configurable by operating system (OS) plug-and-play configuration software. For example, the configuration software utilizes established configuration mechanism as defined by Peripheral Component Interconnect (PCI) or PCI Express specifications. Typically, the configuration mechanisms utilize memory or Input/Output (IO) mapped configuration region for generating configuration transactions on the respective interconnect.

One example of configuration is done by a chipset, as depicted in connection with FIG. 1. In order to configure Integrated Device 1 (incorporated within Processor 2), a chipset translates the required configuration cycle. Therefore, the chipset needs to route the configuration cycle from either processor 1 or processor 2 back to processor 2. However, current generation processor buses do not have supported configuration cycles for this routing. Another configuration example is the processor internally decoding the memory or 10 access for configuration and not generating an access to the chipset for the integrated device 1. However, this does not allow for configuration accesses from processor 1 to be routed to the integrated device 1 in processor 2 due to lack of configuration cycles on current processor buses. In yet another example, shrink wrap operating systems may be used for configuration. However, they do not support situations where an integrated device is visible from some processors but not others.

### BRIEF DESCRIPTION OF THE DRAWINGS

Subject matter is particularly pointed out and distinctly claimed in the concluding portion of the specification. The claimed subject matter, however, both as to organization and method of operation, together with objects, features, and advantages thereof, may best be understood by reference to the following detailed description when read with the accompanying drawings in which:

FIG. 1 is a prior art method of a flowchart for configuration of an integrated device by a chipset.

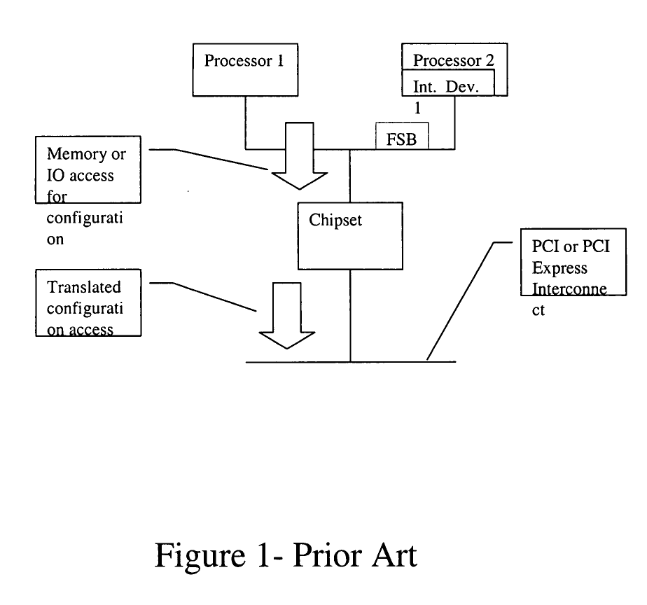

FIG. 2 is an apparatus to facilitate configuration of an integrated device by a processor in accordance with the claimed subject matter.

FIG. 3 is a system diagram illustrating a system that may employ the embodiment of FIG. 2 or FIG. 4 or both.

FIG. 4 is a decoder as utilized by one embodiment.

### DETAILED DESCRIPTION

In the following detailed description, numerous specific details are set forth in order to provide a thorough understanding of the claimed subject matter. However, it will be understood by those skilled in the art that the claimed subject matter may be practiced without these specific details. In other instances, well-known methods, procedures, components and circuits have not been described in detail so as not to obscure the claimed subject matter.

An area of current technological development relates to being able to configure integrated devices within a processor or network component. As previously described, chipsets translate the configuration cycle. Also, prior art configuration schemes are not supported by processor buses for multiprocessor systems.

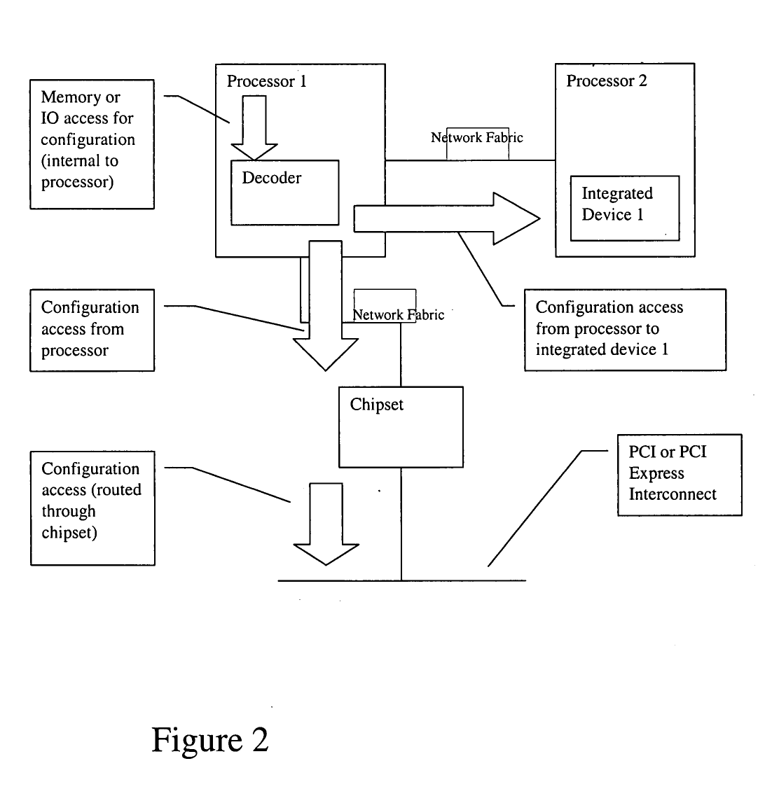

In contrast, the claimed subject matter supports configuration by facilitating translation of the memory or IO mapped configuration access from a processor to a PCI or PCI Express configuration cycle and is done natively by the processor, as depicted in connection with FIG. 2.

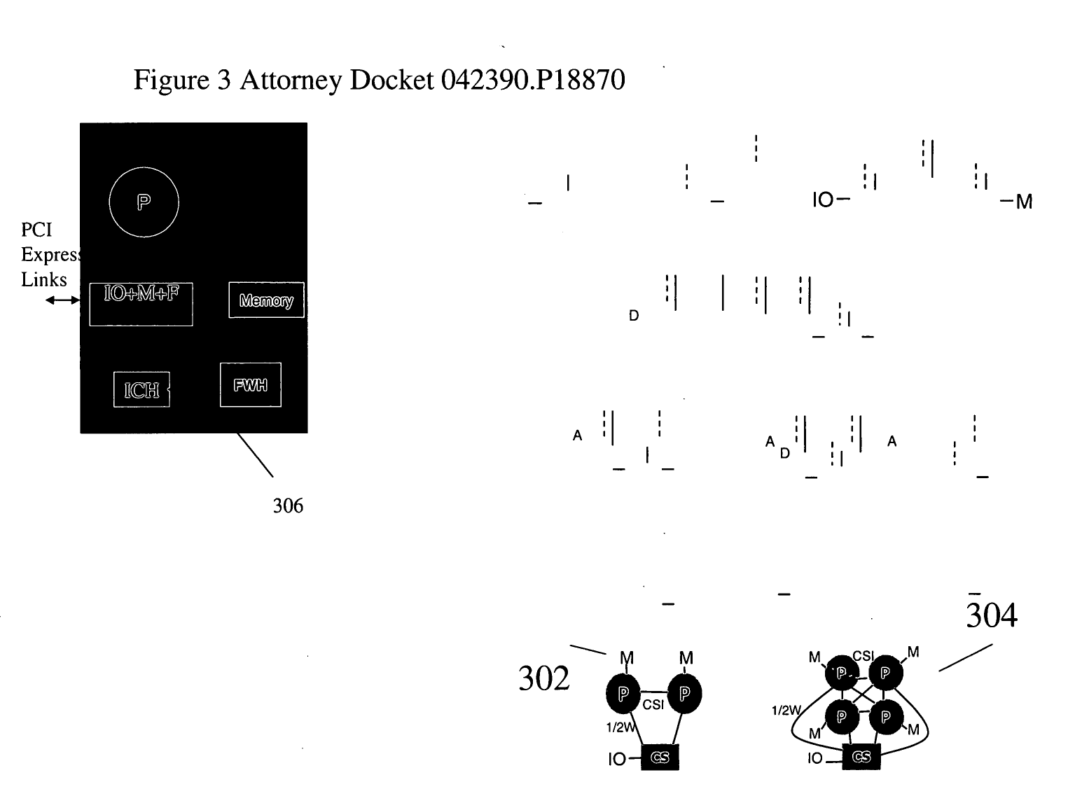

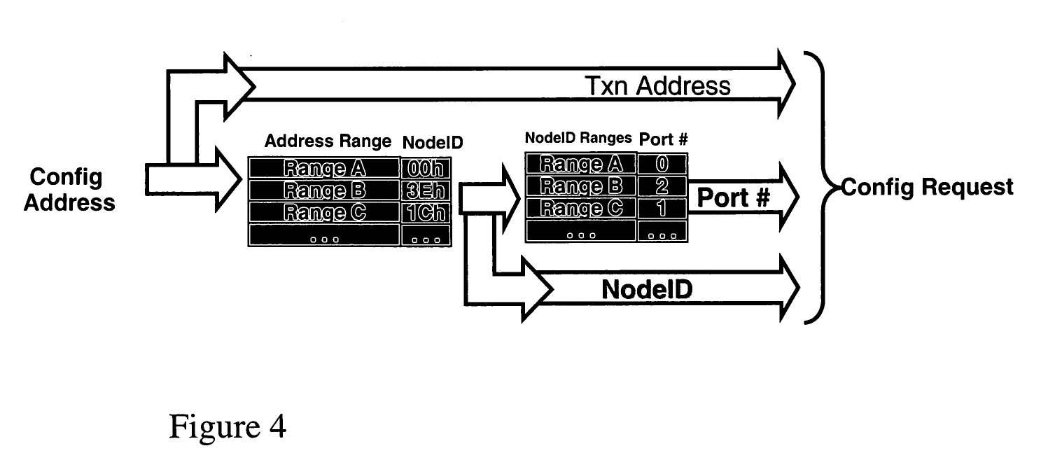

FIG. 2 is an apparatus to facilitate configuration of an integrated device by a processor in accordance with the claimed subject matter. The apparatus depicts a decoder in processor 1. The decoder is discussed further in connection with FIG. 4. In one embodiment, the decoder internally converts a memory or IO access for configuration to a configuration cycle. In contrast, the prior art facilitates the chipset translating the configuration cycle. Subsequently, the configuration cycle is routed either to a chipset or to the integrated device in processor 2 based at least in part on routing information. In the embodiment for routing the configuration cycle to the chipset, the chipset receives the configuration access from the decoder via a network fabric. Subsequently, the chipset forwards the translated configuration access via a PCI or PCI Express Interconnect. In the other embodiment for routing the configuration cycle to the integrated device, the integrated device receives the configuration access via a network fabric. In both of the previous embodiments, the routing of the configuration cycle to either the chipset or integrated device is based at least in part on the routing information. The network fabric is discussed in further detail in connection with FIG. 3.

Therefore, an integrated device may be configured while using the existing configuration mechanisms for the PCI or PCI Express interconnects. Furthermore, the claimed subject matter does not suffer from processor affinity issues since the entire configuration space is globally visible to all components (i.e. all devices are visible to all processors). Therefore, the claimed subject matter enables processor and/or network components with integrated devices in multi-processor systems to be configured by existing shrink-wrap operating systems.

In another embodiment for use for a PCI-Express example, there is a bridge from the chipset to Processor 2. Upon receiving the configuration access, the chipset forwards the configuration access to processor 2.

In one embodiment, the method for configuration depicted in FIG. 2 is incorporated and implemented in software. For example, the software may be stored in an electronically-accessible medium that includes any mechanism that provides (i.e., stores and/or transmits) content (e.g., computer executable instructions) in a form readable by an electronic device (e.g., a computer, a personal digital assistant, a cellular telephone). For example, a machine-accessible medium includes read only memory (ROM); random access memory (RAM); magnetic disk storage media; optical storage media; flash memory devices; electrical, optical, acoustical or other form of propagated signals (e.g., carrier waves, infrared signals, digital signals).

FIG. 3 depicts a point to point system with one or more processors. The claimed subject matter comprises several embodiments, one with one processor 306, one with two processors (P) 302 and one with four processors (P) 304. In embodiments 302 and 304, each processor is coupled to a memory (M) and is connected to each processor via a network fabric may comprise either or all of: a link layer, a protocol layer, a routing layer, a transport layer, and a physical layer. The fabric facilitates transporting messages from one protocol (home or caching agent) to another protocol for a point to point network. As previously described, the system of a network fabric supports any of the embodiments depicted in connection with embodiments depicted in FIGS. 2 and 4.

For embodiment 306, the uni-processor P is coupled to graphics and memory control, depicted as IO+M+F, via a network fabric link that corresponds to a layered protocol scheme. The graphics and memory control is coupled to memory and is capable of receiving and transmitting via PCI Express Links. Likewise, the graphics and memory control is coupled to the ICH. Furthermore, the ICH is coupled to a firmware hub (FWH) via a LPC bus. Also, for a different uni-processor embodiment, the processor would have external network fabric links. The processor may have multiple cores with split or shared caches with each core coupled to a Xbar router and a non-routing global links interface. Thus, the external network fabric links are coupled to the Xbar router and a non-routing global links interface.

FIG. 4 is a decoder as utilized by one embodiment. In one embodiment, the decoder receives a configuration address (config address). In this embodiment, the config address may come from either a memory address (e.g. IPF and PCI-E Enhanced Config) or from a register internal to the CPU. If the config address is from a memory address, the Addr decoder indicates that it's a Config cycle. Otherwise, this is determined prior to the Addr decoder Based on the config address, a nodeId and a port number is retrieved and forwarded as part of the configuration request.

Although the claimed subject matter has been described with reference to specific embodiments, this description is not meant to be construed in a limiting sense. Various modifications of the disclosed embodiment, as well as alternative embodiments of the claimed subject matter, will become apparent to persons skilled in the art upon reference to the description of the claimed subject matter. It is contemplated, therefore, that such modifications can be made without departing from the spirit or scope of the claimed subject matter as defined in the appended claims.

1. A method for configuring an integrated device in a first processor comprising:
decoding a memory configuration access within a second processor, the second processor coupled to the first processor, to a configuration cycle;
routing the configuration cycle to a chipset based at least in part on a routing information; and
forwarding the configuration cycle.

2. The method of claim 1 wherein the configuration cycle is routed to the chipset via a network fabric.

3. The method of claim 1 wherein the network fabric is a plurality of point to point links.

4. The method of claim 1 wherein the chipset has a bridge and adheres to a PCI type interconnect that is either PCI or PCI Express.

5. The method of claim 2 wherein the second processor is coupled to the first processor via the network fabric.

6. A method for configuring an integrated device in a first processor comprising:
decoding an Input Output (10) configuration access within a second processor, coupled to a first processor, to a configuration cycle; and
routing the configuration cycle to the integrated device based at least in part on a routing information.

7. The method of claim 6 wherein the configuration cycle is routed to the integrated device via a network fabric.

8. The method of claim 6 wherein the network fabric is a plurality of point to point links.

9. The method of claim 6 wherein the configuration adheres to a PCI type interconnect.

10. The method of claim 6 wherein the PCI type interconnect is either PCI or PCI Express.

11. The method of claim 7 wherein the second processor is coupled to the first processor via the network fabric.

12. A processor comprising:
a decoder to decode either a memory or IO configuration access to a configuration cycle; and
to transmit the configuration cycle to either a chipset or integrated device.

13. The processor of claim 12 wherein the transmission of configuration cycle to either a chipset or integrated device is via a PCI type interconnect that is either PCI or PCI Express.

14. The processor of claim 12 wherein the configuration cycle is routed to the integrated device or chipset via a network fabric.

15. A system comprising:
a first processor with an decoder coupled to a second network component with an integrated device,
the decoder to decode either a memory or 10 configuration access to a configuration cycle; and
to transmit the configuration cycle to either a chipset or integrated device, wherein the configuration cycle adheres to a PCI type interconnect.

16. The system of claim 15 wherein the PCI type interconnect is either PCI or PCI Express.

17. The system of claim 15 wherein the configuration cycle is routed to the integrated device or chipset via a network fabric.

18. An article of manufacture comprising:
a machine-readable medium having a plurality of machine readable instructions, wherein when the instructions are executed by a system, the instructions provide to configure an integrated device in a processor or network component by:
decoding either a memory or 10 configuration access to a configuration cycle; and
transmitting the configuration cycle to either a chipset or integrated device, wherein the configuration cycle adheres to a PCI type interconnect.

19. The article of manufacture of claim 18 wherein the chipset or integrated device is coupled to the decoder via a network fabric.

20. The article of manufacture of claim 18 wherein the PCI type interconnect is either PCI or PCI Express.

21. A method for configuring an integrated device in a first processor comprising:
decoding a memory configuration access within a second processor, the second processor coupled to the first processor, to a configuration cycle; and
routing the configuration cycle from a chipset to the first processor via a bridge.
